(19) United States
(12) Patent Application Publication
(10) Pub. No.: US 2026/0093050 A1
(43) Pub. Date: Apr. 2, 2026

(54) NEUTRON OR MIXED FIELD DOSIMETER

(71) Applicant: UNIVERSITY OF SOUTH FLORIDA, Tampa, FL (US)

(72) Inventors: Nathan GALLANT, Tampa, FL (US); Omololu MAKINDE, Tampa, FL (US)

(21) Appl. No.: 19/346,103

(22) Filed: Sep. 30, 2025

Related U.S. Application Data
(60) Provisional application No. 63/700,898, filed on Sep. 30, 2024.

(51) Int. Cl. G01T 3/00; G01N 23/207

(52) U.S. Cl. CPC G01T 3/00; G01N 23/2076

(57) ABSTRACT

Disclosed are techniques involving the acquisition of an X-ray diffraction (XRD) spectrum from a sample of a crystalline material, comparison of the obtained XRD spectrum to a reference XRD spectrum associated with the crystalline material, determination of neutron radiation exposure based on the comparison, and output of the neutron radiation exposure. The comparison reflects changes in diffraction features attributable to neutron-induced lattice modifications. These changes may include variations in peak position, intensity, or width, which correlate with exposure levels. The output may represent a quantified dose or a classification of exposure. Such techniques enable non-destructive assessment of neutron radiation effects using spectral data derived from crystalline materials.

### CROSS REFERENCE TO RELATED APPLICATIONS

This application claims priority to U.S. Provisional Patent Application No. 63/700,898, filed on Sep. 30, 2024, the entire contents of which are incorporated herein by reference for all purposes.

### STATEMENT OF GOVERNMENT SUPPORT

This invention was made with government support under Award No. HU000124P0042 awarded by the Department of Defense. The government has certain rights in the invention.

### BACKGROUND

Alanine-based dosimetry has been widely adopted for high-dose gamma radiation measurement due to its stable free radical formation upon exposure to ionizing radiation. When irradiated, alanine produces a specific free radical that can be quantified using Electron Paramagnetic Resonance (EPR), a technique that measures the resonant absorption of electromagnetic energy by unpaired electrons in a magnetic field. The EPR signal amplitude is directly proportional to the concentration of radiation-induced free radicals, making alanine a reliable and reproducible detector for gamma radiation fields. This system has been standardized for photon and electron dosimetry and is used in applications such as sterilization, food irradiation, polymer modification, and medical therapy.

Despite its success in gamma dosimetry, alanine's response to neutron radiation remains problematic. Neutron interactions with alanine vary significantly depending on neutron energy. At thermal energies, neutrons do not produce sufficient free radicals to be detected by EPR, as their interactions are primarily with atomic nuclei rather than electrons. This contrasts with gamma rays, which interact directly with electrons and reliably produce measurable free radicals. Consequently, alanine EPR systems have not been standardized for neutron or mixed-field dosimetry, and their neutron sensitivity is considered unreliable and inconsistent.

Several research efforts have attempted to overcome these limitations. In 1994, scientists at Sandia National Laboratories explored a dual-detector system combining alanine with CaF₂:Mn thermoluminescent dosimeters to separate neutron and gamma contributions. While promising, the system faced unresolved issues in accurately isolating photon dose. Other researchers have experimented with doping alanine using neutron-reactive materials such as gadolinium oxide or lithium formate. These additives were intended to enhance neutron sensitivity by inducing secondary gamma emissions detectable via EPR. However, these approaches introduced significant errors—up to 100% in gamma dose prediction and 10% in neutron dose estimation—making them unsuitable for precise mixed-field dosimetry.

Further studies have shown that the neutron response of alanine is highly dependent on neutron energy and dose rate. For example, experiments conducted at the TRIGA reactor in Mainz demonstrated that alanine doped with gadolinium oxide exhibited different responses in fast and thermal neutron spectra but required detailed knowledge of the neutron spectrum to interpret results accurately. Additionally, activation reactions within alanine pellets can generate radiation that contributes to free radical formation, further complicating dose measurement and reducing reliability in neutron-rich environments.

These challenges have led to a partial suspension of alanine-based calibration services for neutron dosimetry by institutions such as the National Institute of Standards and Technology (NIST), citing dose rate dependence and lack of standardization. While alanine remains a gold standard for gamma dosimetry, its application in neutron or mixed-field environments continues to face significant technical hurdles.

### BRIEF SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. It is meant, in part, to present concepts of one or more aspects of the disclosure in a simplified form as a prelude to the more detailed description that is presented later.

In some aspects, the present disclosure relates to techniques for determining neutron radiation exposure using X-ray diffraction (XRD) analysis of crystalline materials. These aspects include obtaining an XRD spectrum of a sample, comparing the obtained spectrum to a reference spectrum associated with the same material, determining neutron radiation exposure based on the comparison, and outputting the exposure. The output may include a positive indication of exposure or a quantitative dose value. The crystalline material may be organic, including amino-acid based compounds such as alanine or alpha-alanine. Additional aspects include determining XRD feature measurements and inputting those into a computational model trained to correlate spectral features with neutron dosage. The model may output a dosage value indicative of the exposure received. Further embodiments include devices comprising a sample receptacle, an X-ray spectrometer, comparison circuitry, and an output interface. The circuitry may include processors or application-specific integrated circuits (ASICs) and may be configured to execute stored instructions for performing the described operations. Still further aspects include non-transitory computer-readable media storing instructions for executing the operations described above. These and other aspects of the disclosure will become more fully understood upon review of the detailed description and accompanying figures.

### BRIEF DESCRIPTION OF DRAWINGS

FIG. 1A is a schematic diagram of a laboratory-oriented neutron dosimetry system.

FIG. 1B is a schematic diagram of a field-deployable neutron dosimetry system.

FIG. 2 is a flowchart illustrating a method for determining neutron exposure via x-ray diffraction (XRD).

FIG. 3 is a diagram showing a workflow for developing predictive models from XRD data.

FIG. 4 is a block diagram of a dosimetry system architecture.

FIG. 5A is a table of experimental data related to neutron dose analysis.

FIG. 5B is a second table of experimental data related to neutron dose analysis.

FIG. 6 is a graphical representation of experimental data related to neutron dosimetry analysis.

FIG. 7 is a graph depicting outcomes from dosimetry testing.

FIG. 8 is another graph depicting outcomes from dosimetry testing.

FIG. 9 is another graphical representation of experimental data related to neutron dosimetry analysis.

FIGS. 10A-C are box plots illustrating comparison between gamma, mixed, and radiation-free samples.

FIG. 11 is a confusion matrix illustrating discrimination between gamma, mixed, and radiation-free samples.

### DETAILED DESCRIPTION

The present disclosure describes systems and methods for radiation dosimetry and spectrum analysis using organic crystalline materials in conjunction with X-ray diffraction (XRD). In some embodiments, the system is configured to detect and quantify radiation exposure by analyzing changes in crystal symmetry that occur following irradiation. XRD may be used to characterize structural modifications in irradiated samples, and in certain implementations, computational models trained on diffraction spectra may support dose estimation. These models may be deployed in laboratory settings or integrated into portable systems for use in various operational environments.

For example, alanine is an amino acid that produces a stable free radical in the presence of ionizing radiation. This property enables its use in dosimetry systems, particularly via EPR, which measures the dose stored in the microcrystalline alanine. However, neutron sensitivity in alanine has been shown to depend on neutron energy and dose rate, complicating its use in mixed field environments. The present technology addresses this limitation via a measurement technique that is sensitive to neutron-induced changes in the crystal lattice of alanine, while remaining insensitive to gamma radiation alone.

The described system may be applicable in a range of settings where radiation monitoring is required. Potential users include personnel working in nuclear facilities, emergency response teams addressing radiological incidents, and defense organizations operating in areas with potential radiation exposure. The system may provide non-destructive measurements and may be compatible with portable formats to support use in both routine monitoring and rapid assessment scenarios.

Crystalline materials suitable for use with the disclosed technology include any solid-state substances possessing ordered lattice structures that exhibit radiation-sensitive behavior detectable via X-ray diffraction (XRD). While various examples are described below where the crystalline material may comprise alpha-alanine, references to alanine are intended to be illustrative and not limiting. The technology is equally applicable to other organic crystalline materials, such as amino acids, including beta-alanine, glycine, and additional proteinogenic or non-proteinogenic amino acids capable of forming crystalline phases. Further suitable materials include further organic crystals such as saccharides, urea, benzoic acid derivatives, phenol compounds, and solid-state sugars, as well as inorganic crystals including solid alkaline-earth metal dithionates, lithium formate, potassium persulfate, hydroxyapatite, fluorapatite, etc.

In some embodiments, the disclosed neutron dosimetry system may be implemented in clinical and research environments to provide high-resolution, empirical measurements of radiation dose. Without limitation, the system may be deployed during neutron-based therapies, such as boron neutron capture therapy (BNCT), to monitor patient exposure and verify compliance with occupational dose limits for healthcare personnel. The system may further be used to assess shielding performance in treatment rooms and adjacent areas, and to support experimental investigations involving neutron scattering, activation analysis, or radiobiological studies. In certain embodiments, the system may be configured to evaluate the performance of shielding materials or dosimetric compounds under controlled irradiation conditions. The system may also support longitudinal monitoring of cumulative exposure in personnel working near neutron-emitting sources, with dose data optionally integrated into laboratory information management systems (LIMS) or electronic medical records (EMRs). Additionally, the system may be used to validate computational models of radiation transport and dose deposition by providing empirical benchmarking data. These examples are provided for illustrative purposes only and do not represent a limitation on the scope of potential applications.

In further embodiments, the system may be adapted for use in industrial, defense, and environmental monitoring contexts, including deployment in field conditions where neutron radiation is present or suspected. For example, the system may be installed in nuclear power plants to monitor dose levels near reactor cores, spent fuel storage areas, or neutron generators, and may support both routine safety audits and emergency response protocols. The system may also be configured for use in naval propulsion systems, aerospace testing facilities, and military applications involving neutron-emitting equipment, such as weapons, propulsion systems, or detection technologies. Mobile implementations may be deployed in dynamic environments, including disaster response operations, border inspection stations, and mobile laboratories. In environmental monitoring scenarios, the system may be positioned near industrial facilities, research reactors, or waste repositories to detect ambient neutron dose levels and identify anomalies. In some embodiments, the system may further support certification, validation, and regulatory compliance processes for radiation-emitting devices and protective equipment, including verification of shielding performance, calibration algorithms, and reference standards. Dual-modality capability may enable independent quantification of neutron and gamma contributions, facilitating qualification of mixed-field dosimetry systems and integration into quality assurance workflows. These embodiments are presented as non-limiting examples of the broader range of operational contexts in which the system may be utilized.

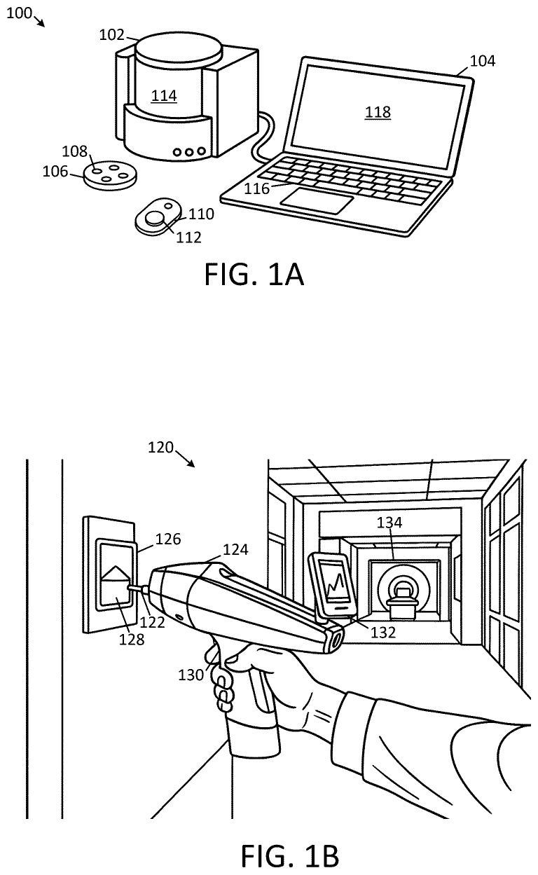

FIGS. 1A and 1B illustrate example implementations of the described technology. The disclosed neutron dosimetry system is configured to estimate radiation dose in environments containing neutron or mixed-field radiation, using crystalline organic materials such as alpha-alanine as the sensing medium. The system may be implemented in laboratory settings for high-resolution analysis or deployed in field environments for real-time monitoring near neutron-emitting sources. In some embodiments, the system comprises a dual-modality architecture that integrates X-ray diffraction (XRD) and electron paramagnetic resonance (EPR) techniques to enable discrimination between neutron and gamma radiation components. The XRD subsystem is configured to detect lattice distortions induced by neutron interactions, while the EPR subsystem provides complementary dose measurements based on stable free radical formation.

Referring now to FIG. 1A, a neutron dosimetry system 100 is illustrated, which may be configured to perform high-resolution X-ray diffraction (XRD) analysis of organic crystalline materials to determine neutron radiation exposure. In some embodiments, the system 100 includes an X-ray diffraction apparatus 102, a computer 104, a first sample holder 106 containing a first sample 108, a second sample holder 110 containing a second sample 112, a receptacle 114, a user interface 116, and an output interface 118.

The X-ray diffraction apparatus 102 may comprise an X-ray source and a detector array configured to acquire diffraction spectra. The apparatus 102 only outputs the spectrum; the processing system is used to detect differences in peak symmetry, intensity, and position that are indicative of neutron-induced lattice distortions. In some cases, the system 100 may operate without rotational staging or angular alignment of the sample, and may instead utilize fixed-angle geometries suitable for multi-crystalline or pelletized materials. Examples of such apparatus include powder diffractometers, fixed-angle bench-top systems, portable field analyzers, and compact XRD scanners.

The first and second sample holders 106 and 110 may be configured to receive a wide variety of sample types and form factors. In some embodiments, the samples may include pressed pellets of organic crystalline material, loose powders, or thin films deposited on substrates. The samples may be housed in sealed containers, open trays, or temperature-controlled environments depending on the application. Sample types may vary based on the intended use case, such as calibration standards, environmental monitors, or personnel dosimeters. In further examples, samples may be embedded in composite matrices, suspended in gels, or affixed to flexible supports for deployment in constrained or irregular geometries. The system may accommodate both single-use and reusable sample formats, and may include mechanisms for automated sample exchange or multi-sample analysis.

The receptacle 114 may serve as a staging area for additional samples or may be used to contain samples following analysis. In some examples, the receptacle may be integrated into the XRD apparatus 102 and configured as a multi-slot tray, shielded container, or automated carousel system.

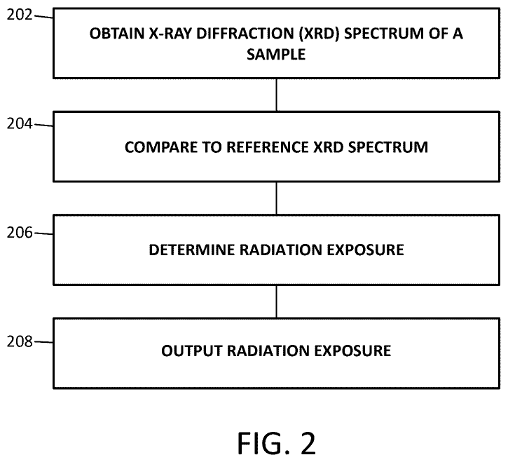

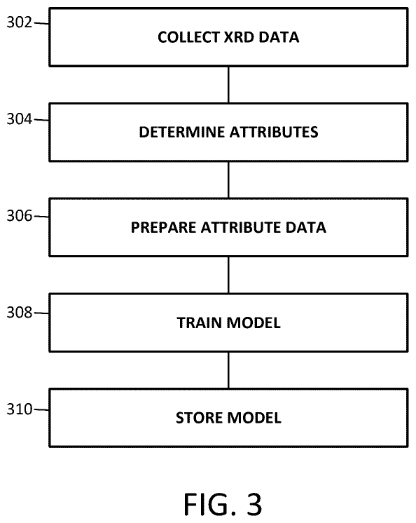

The computer 104 may be operatively coupled to the XRD apparatus 102 and configured to execute software instructions for spectrum acquisition, feature extraction, and dose estimation. In some embodiments, the computer 104 includes a processor and a non-transitory computer-readable medium storing instructions that implement a computational model trained to correlate XRD-derived features with neutron dose. The model may utilize regression techniques, machine learning algorithms, or statistical fitting methods to generate a quantitative output from the acquired spectrum, which may then be mapped to a dose value or exposure classification. In further examples, the model may be calibrated using known dose curves and validated against standard dosimetric methods. Examples of computational models include linear regression models, support vector machines, neural networks, and polynomial curve fitting routines. Further details regarding the computational model and its implementation are described with respect to FIGS. 2 and 3.

The user interface 116 may allow an operator to initiate measurements, configure analysis parameters, and view intermediate results. Examples of user interfaces include touchscreen panels, graphical desktop applications, command-line interfaces, web-based dashboards, physical keyboards, touchpads, and voice-activated controls.

The output interface 118 may be configured to display or transmit the final dose estimation, which may include a binary indication of neutron exposure, a quantitative dose value, or a dose rate. In some embodiments, the output interface 118 may be connected to a remote monitoring system, a laboratory information management system (LIMS), or a safety reporting framework. Examples of output interfaces include digital displays, USB data ports, wireless transmitters, and cloud synchronization modules.

In addition to XRD, Electron Paramagnetic Resonance (EPR) may be employed to determine the total radiation dose in a mixed field environment. EPR is particularly effective for detecting gamma radiation through the measurement of stable free radicals formed in alanine upon exposure. The system may include an EPR spectrometer operatively coupled to the computer 104, which processes both XRD and EPR data to generate a comprehensive dose profile. In some embodiments, the EPR spectrometer may be housed separately from the XRD apparatus and connected via a data interface. In other embodiments, the EPR measurement system may be integrated into the same housing as the XRD apparatus 102 and computer 104, forming a unified dual-modality dosimetry system. The combined system may include shared sample holders, synchronized measurement protocols, and unified data processing pipelines. Alternative implementations may include modular configurations where EPR and XRD components are deployed independently and results are merged post-analysis.

Referring now to FIG. 1B, an on-site neutron dosimetry system 120 is illustrated, which may be configured to perform rapid X-ray diffraction analysis of alanine-based dosimetric samples in field environments.

In some embodiments, the system 120 includes a radiation dosimeter 124, which comprises an integrated X-ray source and detector 122, a user interface 130, and an output interface 132. The integrated X-ray source and detector 122 may be housed in a compact unit suitable for portable or field-deployable applications. In some examples, the unit may include a miniaturized X-ray tube and a solid-state detector array configured to acquire diffraction spectra. The system may be designed to operate without rotational alignment or precision angular control, and may instead rely on fixed geometries optimized for rapid screening. Examples of integrated units include handheld analyzers, suitcase-style diagnostic kits, and modular sensor arrays.

The user interface 130 may be a trigger button configured to initiate measurement, while the output interface 132 may be a display integrated into the handheld apparatus 124. In some embodiments, the system may operate autonomously or under remote supervision and may include wireless communication capabilities for data transmission to centralized databases, safety monitoring platforms, or cloud-based analysis services. Examples of user and output interfaces include mobile apps, Bluetooth-enabled displays, satellite uplinks, and secure web portals.

The radiation dosimeter 124 may further include embedded control circuitry configured to manage spectrum acquisition, data processing, and system operation. In some embodiments, the control circuitry may comprise a processor and a non-transitory computer-readable medium storing instructions for executing dose estimation algorithms. In other examples, the control circuitry may be implemented using an application-specific integrated circuit (ASIC) optimized for low-power, high-speed processing in portable environments. Additional implementations may include microcontrollers (MCUs), field-programmable gate arrays (FPGAs), digital signal processors (DSPs), or system-on-chip (SoC) architectures. These embedded systems may be selected based on application-specific constraints such as power consumption, computational throughput, form factor, and environmental ruggedness. The control circuitry may also support real-time data logging, wireless communication protocols, and automated calibration routines. In some cases, the circuitry may be integrated with onboard memory and sensor interfaces to enable autonomous operation without external computing resources. The system may further include firmware for managing device states, initiating measurements, and transmitting results to external platforms. Examples of supported platforms include cloud-based analytics services, laboratory information management systems (LIMS), and mobile diagnostic applications.

The neutron source 134 may represent a radiation-emitting device being monitored by the system. In the illustrated example, the neutron source may be a medical neutron source, such as one associated with a research accelerator, boron neutron capture therapy (BNCT) system, or fast neutron imaging device. The system may be used to monitor shielding or exposure levels using wall-mounted alanine samples. More generally, the neutron source may be any radiation-emitting device under observation.

The sample holder 126 may be configured to receive alanine-based dosimetric samples that have been exposed to neutron radiation in situ. The sample 128 may comprise a pellet, powder, or crystalline matrix of organic material positioned near the neutron source. In some embodiments, the sample may be affixed to a wall, embedded in a monitoring fixture, or placed within a containment vessel. The sample may remain in place for extended durations and be periodically analyzed using the dosimetry system. Alternative techniques for in-situ monitoring may include automated scanning of fixed sample arrays, robotic sample retrieval and replacement, or integration with environmental monitoring stations. Examples of sample holders include clip-in mounts, magnetic trays, and temperature-controlled chambers.

FIG. 2 illustrates a method for determining neutron radiation exposure using a crystalline material, such as alanine, through X-ray diffraction (XRD) analysis. The method comprises a sequence of steps that may be implemented individually or in combination, and may be executed by a system comprising a dosimeter, spectrometer, processor, and output interface. In some embodiments, the illustrated method may correspond to operational functions of the systems depicted in FIGS. 1A and 1B, including but not limited to the dosimeter badge, the integrated spectrometer unit, and the associated processing and output modules. These systems may be configured to perform one or more steps of the method locally, or may transmit acquired data to a remote server or cloud-based application for further processing, analysis, and reporting. In such configurations, the server may execute comparison algorithms, dose estimation models, and reporting routines, while the local system performs data acquisition and preliminary preprocessing. The method may be embodied in hardware, software, firmware, or any combination thereof, and may be configured for laboratory, clinical, industrial, or field deployment.

In step 202, an XRD spectrum is obtained from a sample comprising a crystalline material. In some embodiments, the sample may include an amino-acid-based crystalline compound, such as alpha-alanine, beta-alanine, glycine, or other radiation-sensitive organic crystals. The sample may be prepared in pelletized, powdered, or bulk crystalline form and housed in a receptacle configured to minimize background interference and maintain sample integrity during measurement. The receptacle may be constructed from low-scattering materials and may include shielding features to isolate the sample from ambient radiation or mechanical vibrations.

The XRD spectrum may be acquired using a spectrometer configured to scan across a range of Bragg angles, such as 10° to 60°, and may include measurements of peak position, intensity, full-width half-max (FWHM), d-spacing, and tip width. The spectrometer may be benchtop, handheld, or robotic, and may include wireless communication modules for remote data transmission. Acquisition may occur in real-time or post-irradiation, with data stored in a non-transitory computer-readable medium. Embedded processors or application-specific integrated circuits (ASICs) may control the measurement process, and the system may include calibration routines, environmental compensation algorithms, and metadata tagging to ensure reproducibility and traceability of the acquired spectrum.

Depending on the use case, the sample may be in-situ, such as a badge or dog tag worn by personnel undergoing exposure testing; a certification sample irradiated under controlled conditions for regulatory or quality assurance purposes; or a field-deployed sample embedded in flexible substrates or composite matrices for constrained geometries. In further embodiments, the sample may be suspended in gels or affixed to composite matrices for deployment in constrained geometries. The system may support integration with laboratory information management systems (LIMS), electronic medical records (EMRs), or cloud-based analytics platforms.

In some implementations, the XRD spectrum may be pre-processed using noise reduction algorithms, baseline correction, and peak deconvolution to enhance feature extraction. Example techniques include Savitzky-Golay filtering for noise reduction, asymmetric least squares for baseline correction, and Voigt profile fitting for peak deconvolution. These techniques may be applied sequentially or in combination to improve the accuracy and resolution of the extracted spectral features. In some cases, the system may include a graphical user interface (GUI) for real-time visualization of the spectrum and interactive analysis.

In step 204, the obtained XRD spectrum is compared to one or more reference XRD spectra associated with the same crystalline material. The reference spectra may be derived from unirradiated control samples, standardized databases, or previously validated calibration datasets. The comparison may be performed using software routines executed by a processor or ASIC, and may include peak alignment, normalization, and statistical correlation of spectral features. In some embodiments, the comparison may be performed using a model developed as described with respect to FIG. 3.

Neutron radiation induces lattice distortions in crystals, which manifest as measurable changes in XRD features. These changes may include shifts in peak positions, reductions in peak intensity, broadening of peaks, and variations in peak count. Such distortions alter the diffraction pattern in ways that are distinct from gamma radiation effects, allowing for neutron-specific detection. Feature retrieval techniques are applied to extract relevant spectral characteristics such as peak shifts, intensity ratios, and angular deviations. Feature reduction algorithms are then used to compress the data into a manageable set of indicators for analysis.

The system may calculate a figure of merit based on differences in peak intensity, angle count, or other structural parameters, and may be used to quantify the extent of neutron exposure. This figure of merit may include, but is not limited to, cosine similarity, Euclidean distance, or weighted deviation scores across selected spectral features. Reference spectra may be dynamically adjusted based on sample batch, environmental conditions, or irradiation history, and may be stored in a secure database accessible by the system.

The comparison process may also include error bounds, confidence intervals, and uncertainty quantification to support regulatory compliance and scientific reproducibility. Calibration curves may be generated using standardized alanine samples irradiated at known dose rates and validated using independent dosimetric methods. The system may automatically select the appropriate reference spectrum and dose-response curve based on input parameters. Alternative implementations may include metadata such as dose rate, shielding configuration, and irradiation time. The comparison may be visualized through graphical overlays, heatmaps, or tabular reports, and may be used to inform subsequent dose estimation steps.

In step 206, neutron radiation exposure is determined based on the comparison between the obtained and reference XRD spectra. The outputs may include classification (e.g., exposed vs. unexposed), quantitative dose values (e.g., 8.5 Gy), dose rate estimates, or other indications of exposure. The system extracts a set of XRD feature measurements, such as peak shifts, intensity ratios, and angle counts, and inputs them into a computational model configured to determine exposure characteristics.

The computational model may be implemented using supervised learning techniques and may include linear regression, random forest regressors, neural networks, or support vector machines. These models may be stored in a non-transitory computer-readable medium and executed by embedded control circuitry, such as a processor. In the case of an ASIC, the model may be instantiated in custom integrated circuitry, or in a combination of stored data and dedicated processing logic. The system may support dose estimation in mixed-field environments by differentiating neutron-specific spectral changes from gamma-induced effects.

Alternative embodiments may support real-time dose monitoring, batch processing of multiple samples, and integration with external dosimetry systems or safety protocols. The system may include a diagnostic component that flags anomalous results, suggests re-measurement, or recommends alternative analysis pathways. In some cases, the dose determination may be used to validate shielding effectiveness, assess personnel exposure, or support forensic reconstruction of radiation events. The system may be configured to operate autonomously or under user supervision, and may include audit trails for regulatory compliance.

In some embodiments, step 206 may further comprise detecting the presence of, or measuring, a gamma radiation dose. In certain implementations, this may include comparing or analyzing various additional features of X-ray diffraction (XRD) data to assess radiation-induced changes in crystalline structure. For example, the diffraction angle (Pos. [° 20]) may be monitored to identify shifts in peak position indicative of lattice distortion. The peak intensity (Height [cts]) may be evaluated to determine the number of diffracted rays, which is proportional to the density of interacting electrons and may vary with radiation exposure. Additionally, the full width at half maximum on the left side of the peak (FWHM Left [° 20]) may be used to assess peak resolution, where broadening may suggest increased microstrain or defect density. The interplanar spacing (d-spacing [A]) may be calculated to quantify atomic-level changes in lattice geometry. Relative intensity (Rel. Int. [%]) may be compared across multiple peaks to identify variations in phase composition or preferred orientation. Furthermore, the tip width of each peak may be analyzed as a measure of peak sharpness, which may correlate with crystallite size or structural integrity. Collectively, these parameters may be used to infer the extent of gamma radiation exposure and its impact on the material under investigation.

In some embodiments, step 206 may further comprise comparing these features to reference datasets, such as samples that have not been exposed to gamma radiation, in order to identify radiation-induced deviations. In certain implementations, this comparison may be facilitated by rule-based or tree-based classification algorithms configured to distinguish between irradiated and non-irradiated samples. For example, a logistic regression model may be trained using the XRD-derived parameters, such as Pos. [° 20], Height [cts], FWHM Left [° 20], d-spacing [A], Rel. Int. [%], and Tip Width, as input features, enabling the model to predict the likelihood of gamma exposure based on observed structural changes. In another example, a K-nearest neighbor (KNN) classifier may be employed to assign a classification label to a test sample by comparing its feature vector to those of known reference samples, thereby identifying similarities in peak broadening, intensity shifts, or lattice spacing. As another example a generative adversarial model (GAN) may be applied, with a discriminator network to classify X-ray diffraction (XRD) datasets as either gamma-exposed or gamma-unexposed based on a multidimensional analysis of diffraction features.

In some embodiments, step 206 may further comprise performing electron paramagnetic resonance (EPR) analysis on the sample. EPR analysis may be used to detect and quantify free radicals or paramagnetic centers generated in the crystalline material as a result of neutron irradiation. The EPR process typically involves placing the sample in a resonant cavity and exposing it to a magnetic field while sweeping microwave frequencies to detect resonance absorption. The resulting signal may be analyzed to determine the presence, concentration, and characteristics of radiation-induced defects.

The EPR signal may be characterized by its g-factor, line shape, and intensity, which correlate with the type and concentration of paramagnetic species formed during exposure. These features may vary depending on the radiation type, dose, and energy spectrum. The system may include a spectrometer configured for EPR measurements and may apply signal processing techniques such as baseline subtraction, peak fitting, and integration to extract quantitative metrics. These metrics may be used to corroborate XRD-based dose estimates or to provide independent verification of neutron exposure.

EPR analysis may be particularly useful for long-term dosimetry, as the paramagnetic centers in alanine are stable over extended periods. This stability enables retrospective dose reconstruction and supports archival monitoring in clinical, industrial, or environmental settings. The system may support automated EPR scanning, data logging, and integration with the same output and reporting infrastructure used for XRD analysis. In some implementations, EPR data may be fused with XRD data to improve accuracy, extend detection ranges, or enable multi-modal radiation profiling.

In further embodiments, the combination of XRD and EPR analysis may be leveraged to isolate and characterize different components of a mixed radiation field. For example, XRD may be more sensitive to structural distortions caused by neutron interactions, while EPR may preferentially detect gamma-induced paramagnetic centers. By analyzing the differential response of the sample across both modalities, the system may deconvolve the contributions of neutron and gamma radiation, enabling more precise quantification of each component. This dual-modality approach may be particularly advantageous in environments such as nuclear reactors, space missions, or medical therapies involving mixed-field exposures, where accurate discrimination between radiation types is critical for safety, compliance, and treatment planning.

In step 208, the radiation exposure determined in step 206 may be output through a variety of interfaces. The output may be a binary indication of exposure, a quantitative dose value, or a classification label (e.g., low, medium, high exposure). The output interface may include a digital display, USB port, wireless transmitter, or software API, and may be configured to transmit results to external systems such as LIMS, EMRs, or radiation safety dashboards.

The system may generate a report summarizing the spectral analysis, dose estimation, and confidence metrics, and may support export in formats such as PDF, CSV, or XML. In some embodiments, the output may trigger alerts, initiate safety protocols, or inform medical decision-making in clinical environments. The output may also be used to calibrate other dosimetric instruments, validate shielding effectiveness, or support forensic reconstruction of radiation exposure scenarios.

Alternative implementations may include outputs tailored for specific applications, such as reactor safety analysis, boron neutron capture therapy (BNCT), or environmental monitoring. The system may support batch processing and output aggregated dose statistics across multiple samples. In some cases, the output may be stored locally or transmitted to cloud-based analytics platforms for further processing and archival. The output component may include encryption, authentication, and access control features to ensure data security and integrity. The system may support integration with enterprise resource planning (ERP) systems, regulatory reporting tools, and scientific publication platforms. The output may be customizable based on user preferences, institutional requirements, or application-specific constraints.

Referring now to FIG. 3, a method is disclosed for developing a predictive model based on X-ray diffraction (XRD) data obtained from alanine samples subjected to various radiation conditions. The disclosed method may be used to produce models such as those described in FIG. 2. Accompanying the description of each step is an example tested implementation of the step. These descriptions should be understood as non-limiting examples of specific technical implementations.

The method may include step 302, which includes obtaining data. In some embodiments, the method begins with the acquisition of XRD data from crystalline materials, such as alanine, which may be irradiated or unirradiated. Practical implementations include obtaining data via the internet from an offsite repository, performing XRD measurements in a laboratory setting, or accessing archived datasets from previous experiments. For instance, in a medical setting, alanine dosimeters could be retrieved from a clinical radiation therapy suite and scanned using in-house diffractometers. In a research facility, samples exposed to neutron fields could be shipped to a central lab for analysis. In an academic environment, archived alanine spectra from student experiments could be uploaded to a shared repository for retrospective modeling.

The XRD instrumentation may be configured to output a spectrum of refracted X-ray counts as a function of diffraction angle (20), from which multiple quantitative features may be extracted. These features may include, without limitation, Bragg angles, refracted X-ray intensities, interplanar electron spacing, Gaussian pulse intensity, full width at half maximum (FWHM), and tip width. In certain implementations, the extracted features may be concatenated to form a high-dimensional vector representation of the sample. Additional metadata may also be collected depending on the configuration of the XRD system, including detector gain, scan speed, and sample orientation parameters.

The method may further include step 304, which includes determining attribute data to be used to train the model. This step may include pre-processing the data to prepare it for model training. Alternative approaches may include standardizing the number of columns across samples, imputing missing values using statistical or machine learning-based methods, removing zero-only columns, and applying normalization techniques such as z-score normalization or robust scaling. Dimensionality reduction may be performed using techniques like Principal Component Analysis (PCA), Independent Component Analysis (ICA), or t-distributed Stochastic Neighbor Embedding (t-SNE), depending on the desired balance between interpretability and performance. For instance, PCA could be applied to alanine spectra collected from mixed-field irradiated samples to reduce the feature space from hundreds of diffraction attributes to a manageable set of principal components. ICA could be used to isolate independent spectral features corresponding to neutron-specific damage signatures. t-SNE could be employed to visualize clustering patterns among samples exposed to different radiation types, using attributes such as Bragg peak intensity and FWHM.

The method may further include step 306, which includes preparing the attribute data. In some embodiments, the processed attribute data is split into training and testing sets to facilitate supervised learning. The split ratio may vary depending on the dataset size, but a 70/30 split is commonly used. To prevent overfitting, regularization techniques such as Lasso, Ridge, or Elastic Net may be applied. Data augmentation techniques such as synthetic sample generation, noise injection, or bootstrapping may also be employed to increase sample diversity and improve model generalization. For instance, alanine spectra from gamma-irradiated samples could be augmented by injecting Gaussian noise into low-intensity peaks to simulate detector variability. Bootstrapping could be used to resample mixed-field spectra to improve model robustness. Stratified sampling could ensure that training sets contain balanced representations of unirradiated, gamma-only, and neutron-exposed samples. Cross-validation could be performed using k-fold splits to evaluate generalization across different radiation conditions.

In further embodiments, the extracted features may include, but are not limited to, the diffraction angle (Pos. [° 20]), which represents the angular position of each peak and is indicative of specific crystallographic planes within the sample. Peak intensity (Height [cts]) may also be extracted, reflecting the total number of diffracted X-rays at each angle and serving as a proxy for electron density and phase abundance. Additionally, the full width at half maximum on the left side of the peak (FWHM Left [° 20]) may be computed to quantify peak broadening, which may correlate with microstrain, defect density, or crystallite size. The interplanar spacing (d-spacing [Å]) may be derived using Bragg's Law, providing a direct measure of atomic lattice spacing and enabling identification of structural shifts due to radiation exposure or material transformation. Relative intensity (Rel. Int. [%]) may be normalized against the most intense peak to facilitate comparative analysis across multiple diffraction patterns or sample conditions. Finally, tip width may be extracted to characterize the sharpness or fineness of each peak, which may be indicative of resolution limits, overlapping phases, or instrumental effects. These features may be stored as a structured dataset for use in downstream classification, regression, or clustering algorithms, or for direct interpretation in material characterization workflows.

The method may further include step 308, which includes training a predictive model using the processed XRD data. In some embodiments, the model may be selected from among linear models, nonlinear models, ensemble methods, kernel-based methods, or neural networks, depending on the complexity of the data and the desired performance characteristics. For instance, a linear regression model could be trained to predict dose based on peak intensity and FWHM values. An SVR model could be configured with an RBF kernel to capture nonlinear relationships between diffraction angle distributions and neutron dose. Polynomial regression could be used to model curvilinear trends in peak broadening across dose levels. Random forest regressors could be trained to rank feature importance among hundreds of spectral attributes. A CNN could be used to automatically extract hierarchical features from raw spectra, particularly when the dataset includes thousands of samples.

In further embodiments, step 308 may include training or developing predictive models for the detection of gamma radiation or gamma exposure. The method may comprise utilizing the processed XRD data to construct classification or regression models capable of inferring radiation dose levels based on spectral features. In some implementations, the predictive model may be selected from among logistic regression classifiers, K-nearest neighbor (KNN) algorithms, support vector machines (SVMs), decision trees, or other suitable supervised learning techniques. For example, a logistic regression model may be trained to estimate the likelihood of gamma exposure based on combinations of peak intensity, tip width, and d-spacing values. A KNN classifier may be configured to assign exposure categories by comparing the feature vector of a test sample-comprising Pos. [° 20], FWHM Left [° 20], and Rel. Int. [%]—to those of labeled training samples. Additional models may include ensemble methods such as gradient boosting or random forests, which may be used to rank feature importance and improve generalization across heterogeneous datasets. Neural network architectures, including convolutional neural networks (CNNs), may be employed to extract hierarchical patterns from raw diffraction spectra, particularly in cases involving large-scale datasets with high dimensionality.

Each model type may be implemented using standard machine learning libraries such as scikit-learn, TensorFlow, or PyTorch, and may be configured with hyperparameter tuning frameworks such as GridSearchCV or Bayesian optimization.

The method may further include step 310, which includes storing the model. In some embodiments, the trained model is stored on a non-transitory computer-readable medium for future inference. The stored model may be deployed in real-time radiation monitoring environments, particularly in mixed neutron-gamma fields. The storage format may include serialized binary files, cloud-based model registries, or embedded firmware modules, depending on the deployment context.

In tested implementations, XRD data was collected from alanine pellets exposed to three radiation conditions: unirradiated, gamma-irradiated using AFRRI HLCF sources, and mixed neutron-gamma fields using a TRIGA reactor. The raw data from each sample contained up to 343 attributes. These attributes were extracted from the diffraction spectra and stored in structured arrays for further processing. All samples were padded to 53 columns, missing values were replaced with zeros, and zero-only columns were removed. Min-max normalization was applied, and PCA reduced the attribute space from 309 dimensions to 39 principal components, retaining 99.9999% of the variance.

The initial training set included 45 samples: 10 unirradiated, 10 gamma-irradiated, and 25 mixed-field irradiated alanine pellets. The data was split using a 70/30 ratio. Regularization techniques including Lasso, Ridge, and Elastic Net were applied to mitigate overfitting. PCA was used to retain informative features. An additional 24 samples were introduced, expanding the dataset to 69 samples.

To evaluate model performance, multiple regression and classification algorithms were trained and tested. The following table summarizes the results across different model types, including root mean squared error (RMSE) for regression models and accuracy for classification models:

| | | | | Initial | Expanded |
|---|---|---|---|---|---|
| # | Model Type | Configuration Details | Metric | Dataset | Dataset |
| 1 | Linear Regression | ElasticNet with α = 0.001, L1 ratio = 0.5 | RMSE | 9.21 | — |
| 2 | Support Vector | SVR with C = 1000, ε = 0.01, γ = 0.1, | RMSE | 6.67 | 6.84 |
| | Regression | kernel = RBF | | | |
| 3 | Polynomial | Degree = 2, Intercept = True | RMSE | 1.64 | 1.64 |
| | Regression | | | | |
| 4 | Random Forest | Estimators = 20,000, Depth = 10, | RMSE | 5.9 | 5.9 |
| | Regressor | MinSplit = 2, MinLeaf = 2 | | | |
| 5 | Logistic | C = 1, Penalty = L1 | Accuracy | 1.0 | 0.703 |
| | Regression | | | | |

### Additional Configurations Tested Include:

Linear regression models implemented using scikit-learn's ElasticNet class, with hyperparameter tuning across a values from −3 to 3 and L1 ratios from 0 to 1.

SVR models using scikit-learn's SVR class with hyperparameters including C values from 1000 to 1,000,000, ¿ values from 0.01 to 1, and y values including scale, auto, 0.1, and 1. Both linear and RBF kernels were tested.

Polynomial regression models using PolynomialFeatures combined with LinearRegression, testing degrees from 2 to 4 and intercept options.

Random forest regressors configured with estimators ranging from 1000 to 500,000, depths of none, 5, 10, and 15, minimum split values of 2, 5, and 10, and minimum leaf sizes of 1, 2, and 4.

Logistic regression classifiers tested with C values of 0.1, 1, and 10, and penalties of L1 and L2.

All models were trained using PCA-transformed data and serialized using Python's joblib or pickle libraries for future inference.

The model development process is supported by theoretical modeling of neutron interactions with alanine. Neutron scattering cross-section, flux, and atomic displacement are modeled using the equation:

$$R = n \cdot σ ( E ) \cdot Φ$$

where R is the reaction rate, n is the number of alanine atoms, σ(E) is the scattering cross-section, and Φ is the neutron flux. The number of atoms n is calculated using:

$$n = m / M \cdot N\_A$$

where m is the mass of alanine, M is the molecular mass, and N_A is Avogadro's number.

Organic crystals, including alanine, are highly sensitive to neutron scattering due to their hydrogen content. Hydrogen has a large incoherent scattering cross-section, enhancing the detectability of atomic displacements. These displacements manifest as changes in diffraction patterns, which can be quantified and modeled. The disclosed method leverages this sensitivity to distinguish neutron-induced damage from gamma-only exposure, enabling accurate mixed-field radiation dosimetry. The method is compatible with various crystal structures and may be extended to other materials with similar lattice properties.

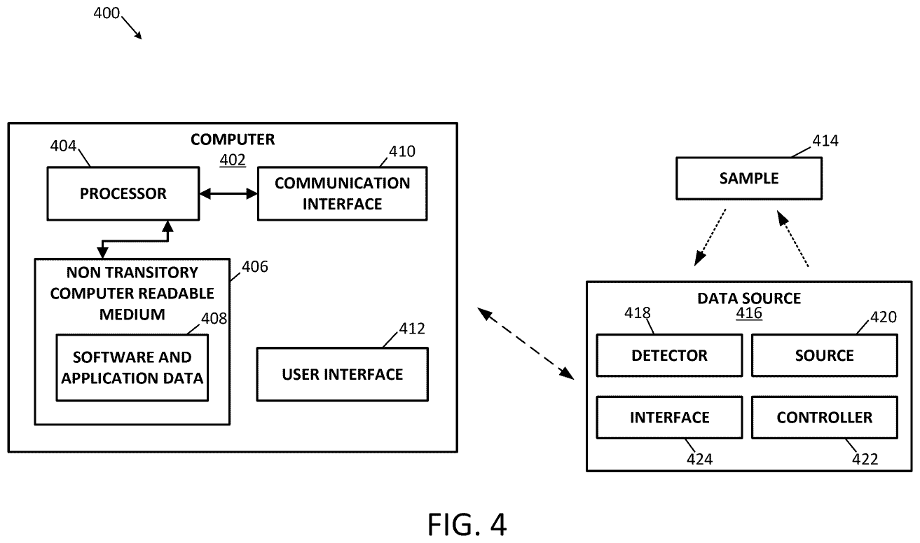

FIG. 4 illustrates a high-level block diagram of a system 400 that may be configured to implement various aspects of the technology described herein. In some implementations, the system 400 may represent a generalized computing and sensing architecture suitable for performing radiation dosimetry, spectral analysis, or other forms of data-driven evaluation of crystalline materials. The system 400 may be embodied in a laboratory workstation, a field-deployable dosimeter, a server-based analytics platform, or a handheld device, and may support both standalone and distributed configurations.

The system 400 may include a computer 402, which may be implemented as a desktop computer, a server, a mobile device, or a specialized dosimetry unit. In some implementations, the computer 402 may be co-housed with other components such as the data source 416 and detector 418, forming an integrated unit similar to the field-deployable system described in FIG. 1B. The computer 402 may include a processor 404, which may be a general-purpose microprocessor, a digital signal processor (DSP), a microcontroller, an application-specific integrated circuit (ASIC), a graphics processing unit (GPU), a neural processing unit (NPU), or other specialized hardware accelerators. The processor 404 may be configured to execute instructions for spectrum acquisition, feature extraction, dose estimation, and other computational tasks, including machine learning inference and real-time control. In alternative configurations, combinations of processors may be used, such as an ARM processor paired with a DSP or GPU.

In some implementations, the processor 404 may be operatively coupled to a non-transitory computer-readable medium 406, which may store software and application data 408. The medium 406 may include RAM, ROM, flash memory, magnetic storage, EEPROM, EPROM, registers, or other suitable memory technologies. In further embodiments, the medium 406 may represent a distributed memory architecture comprising local cache, persistent storage, and remote memory resources accessible via networked interfaces. The software and application data 408 may include machine learning models, calibration datasets, control algorithms, and other executable instructions. These models may be trained using X-ray diffraction (XRD) data from irradiated samples, as described in FIG. 3, and may be configured to estimate neutron dose based on spectral features such as peak shifts, intensity ratios, and angular deviations. Accordingly, the application data 408 may explicitly store the trained model itself, enabling inference operations to be performed locally by the processor 404. In some embodiments, the software and application data 408 may further include modules for customer relationship management (CRM), enabling the system 400 to log, track, and respond to user interactions, service requests, and regulatory submissions.

The computer 402 may further include a communication interface 410, which may support wired or wireless data exchange with external systems. In some implementations, the communication interface 410 may include USB ports, Ethernet adapters, Wi-Fi modules, Bluetooth transceivers, infrared (IR) communication ports, satellite uplinks, etc. The communication interface 410 may enable integration with laboratory information management systems, cloud-based analytics platforms, CRM systems, or remote monitoring dashboards, as described in the output infrastructure of FIG. 2.

A user interface 412 may be provided to allow operators to interact with the system 400. The user interface 412 may include graphical displays, touchscreen panels, physical buttons, voice-activated controls, mobile applications, keyboards, mice, microphones, etc. Output devices may include speakers, printers, display devices, etc. A display controller may also be included to convert stored data into text, graphics, and/or moving images for presentation on the display device. In some implementations, the user interface 412 may support real-time visualization of XRD spectra, configuration of measurement parameters, and review of dose estimation results. Similar interfaces are described in FIG. 1A and FIG. 1B, where users may initiate measurements and view outputs through integrated displays or remote dashboards.

The system 400 may be configured to analyze a sample of crystal material 414. The sample 414 may be housed in a receptacle or sample holder, and may be positioned for irradiation and measurement. The data source 416 may be used to obtain XRD spectrum data and other analytical information regarding the sample 414. In some implementations, the data source 416 may include an XRD spectrometer, a simulation engine, or a database of reference spectra.

An X-ray source 420 may be used to irradiate the sample 414, and a detector 418 may be configured to capture the resulting diffraction pattern. The detector 418 may include a charge-coupled device (CCD), a photodiode array, or other suitable sensor technologies. In some implementations, the detector 418 may be integrated with the X-ray source 420 in a compact unit, as illustrated in FIG. 1B. The acquired data may be processed by the processor 404 using the software and application data 408 to determine characteristics of the sample 414, such as radiation dose or structural integrity.

Control circuitry 422 may be provided to manage the operation of the X-ray source 420, detector 418, and other system components. In some implementations, the control circuitry 422 may include analog and digital circuits, ASICs, microcontrollers, or system-on-chip architectures. The control circuitry 422 may be configured to execute measurement protocols, manage device states, and coordinate data acquisition. Similar control systems are described in FIG. 1B, where embedded processors manage spectrum acquisition and system operation.

An interface 424 may be included to facilitate communication between the system 400 and external devices or users. In some implementations, the interface 424 may be a communication interface, a user interface, or a hybrid module supporting both functions. The interface 424 may enable data exchange, remote control, or system monitoring, and may support integration with external dosimetry systems, safety protocols, CRM platforms, or regulatory reporting tools. In further implementations, the interface 424 may communicate with the computer 402 via the communication interface 410, thereby enabling bidirectional data flow between external systems and the internal processing unit.

The following description presents results of specific experimental implementations that illustrate technical aspects. These implementations are not intended to be limiting, and the disclosed technology may be applied in any suitable manner differing from the experimental design described herein.

The alanine used in this research was a spherocylindrical pellet with a diameter and length of 4.8 mm and 3 mm, respectively. The pellets were sourced from Far West Technology, Inc. from a single production lot composed of 96% L-alanine and 4% binder. Custom holders were created to hold 9-pellet samples in both irradiation facilities and the XRD.

Samples of alanine pellets were analyzed using a Bruker D2 PHASER Diffractometer both pre- and post-irradiation in a gamma only field or a mixed field. The analysis compared changes in the lattice diffraction angles, planes and the counts of diffracted X-rays generated in relation to the irradiated dose. The D2 PHASER is a tabletop system with a 300-Watt X-ray generator. The components necessary to measure the Bragg coherent angles are all included in the system. Measurements used a 1.0 mm divergent slit, and the sample spinner was set to 10 rpm. The X-ray generator voltage and current were 20 kV and 10 mA, respectively. The detector was set in identification mode using the SSD160 internal detector. The X-rays were generated from a copper tube with 1.54184 Å average wavelength.

Preliminary scans of L-alanine pellets spanned the 20 lattice angular range from 0 degrees to 140 degrees. Based on peak analyses, during the XRD analysis, subsequent data acquisition was limited to a range of 20 degrees to 100 degrees. The sample holder was subjected to a variable rotational rate of 10 degrees per minute, ensuring systematic data gathering. Each analysis segment was orchestrated with a step time of 0.2 seconds. The XRD was equipped with two position sensitive detectors (PSD) apertures set at 4.849 degrees and 4.63 degrees. To minimize impacts of sample displacement, each sample was secured in its holder with paraffin film during transportation and irradiation.

To elucidate differences between the pre- and post-irradiation crystal structures, Panalytical High Score software (HS) was used to process the raw XRD spectrum data to identify each peak, the Full Width Half Maximum (FWHM) value for each peak, and the corresponding 2θ diffraction angle. HS analysis involved the systematic removal of background, equipment variability, and K-α peak effects, thereby ensuring data consistency across all measurements. The analysis sequence started with removal of background by adjusting a spectrum scaling factor based on a HS proprietary search algorithm detailed in the program manual. A scaling factor of 1 was used to separate the background and to search for peaks in the XRD data. After peaks were identified, HS was used to search for material matches in the International Centre for Diffraction Data PD5+ database. Pre- and post-irradiation comparisons were analyzed with a two-tailed t-test to determine significant differences.

Prior to irradiation, the batch was analyzed for variation in XRD measurements due to sample placement and container. Nine pellets were placed randomly in the holder 9 times and scanned by XRD. No significant difference was observed due to sample displacement. For spectrum confirmation and to rule out effects of palletization on polycrystallinity, a powdered sample made from ground pellets was scanned in the diffractometer. The pellet and powdered samples were compared to a L-alanine standard spectrum in the XRD database.

Twenty-nine samples, each configured as a 9-pellet setup were irradiated in mixed fields of gamma and neutron radiation generated at the AFRRI TRIGA reactor at doses ranging from 1 to 25 Gy. Nine pellets were arranged in a 3×3 configuration in a custom designed pellet holder, which was employed for both irradiation and XRD analysis. The holder was machined from polymethyl methacrylate (PMMA) and was designed to present the optimal surface uniformity and scanning diameter for the XRD. Its design aimed to securely accommodate nine alanine pellets while minimizing sample displacement through the preirradiation X-ray diffraction analysis, irradiation, and post-irradiation analysis.

Eight samples were irradiated at the AFRRI high level cobalt facility with the NIST certified 60 Co irradiator to observe radiation damage to alanine in pure gamma fields. Samples were irradiated using three different dose rates to deliver 2,4,8, 10,12,14,18 and 20 Gy doses. As a control, 9 unirradiated pellets were crushed into powder for XRD analysis and comparison to reference standards. The powder was prepared and scanned in the same holder as the pellets. In addition, the displacement error of the unirradiated alanine pellets was measured by placing a sample of 9 pellets in 9 random configurations and determining the standard deviation of the number of Bragg angles measured by XRD. The sample displacement represents the variation in the number of observed diffraction angles due to placement of the sample in different configurations in the pellet holder. Displacement error was negligible compared to the variation of the 8 gamma-only and 29 mixed field samples.

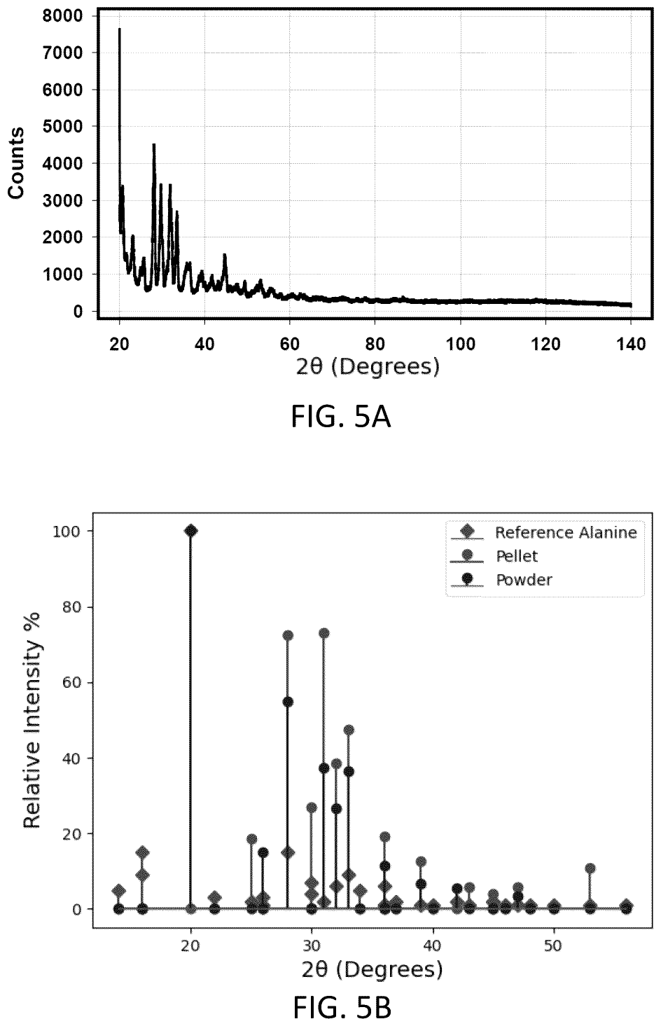

Prior to irradiation, polycrystalline L-alanine pellets commonly used for gamma dosimetry were characterized by XRD (FIG. 5A). XRD is more typically applied to powdered samples, hence a comparison of the pellet measurement to a similar sample of L-alanine crushed into a fine powder was first made as seen in FIG. 5B. A peak analysis, where background removal was consistently applied, showed that the pellets could be measured by XRD as effectively as powdered samples based on the overlap of the significant peaks at similar 2θ angles. Furthermore, the peaks of both samples corresponded to an International Center for Diffraction Data (ICDD) certified L-alanine XRD spectrum. While differences in peak intensity may be attributed to different lateral distributions and/or volumes, the peak locations and number of peaks were highly similar.

### Gamma Irradiation of Alanine Dosimeters

Eight samples were irradiated in a calibrated high-energy 60 Cobalt gamma facility to explore the possibility of observing radiation damage in alanine by gamma radiation alone using XRD. The number of pre- and post-gamma irradiation diffraction angles did not change, irrespective of dose over the range of 2-20 Gy. This result is consistent with a previous study of sterilizing doses of gamma radiation on alanine. Looking closely at the post-irradiation spectral peaks compared to the pre-irradiation spectra clarifies the lack of alteration in the crystal structure over this range of doses. There appears to be no new diffraction planes generated as a result of gamma irradiation, leading to the conclusion that the XRD spectrum is insensitive to gamma radiation.

### Mixed Field Irradiation of Alanine Dosimeters

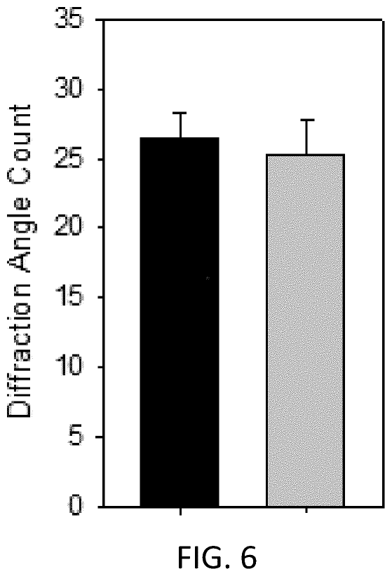

To determine the sensitivity of alanine XRD measurement to mixed fields, the experiment was repeated for a mixed radiation field from the AFRRI 1MW TRIGA Exposure Room 1 (ER1). 29 samples were irradiated in ER1 at doses ranging from 1 to 25 Gray. FIG. 6 shows the change in the number of diffraction angles for the 29 samples irradiated. Each sample was irradiated at a different dose, with sample 5 remaining in the reactor during startup operations to capture possible effects. Each sample demonstrated an increase in the number of diffraction angles, including the lowest dose exposure here of 1 Gray. The average post-irradiation measurement of 38.7±3.6 diffraction angles was a significant increase over the pre-irradiation average of 24.3±1.7. The post-irradiated samples each exhibited additional 2θ angles within the same range as well as numerous new angles beyond 65 degrees. This approximately 60% increase in diffraction angles strongly indicates an altered crystal structure due to the interaction with a mixed field of neutrons and gamma radiation, in contrast to gamma alone.

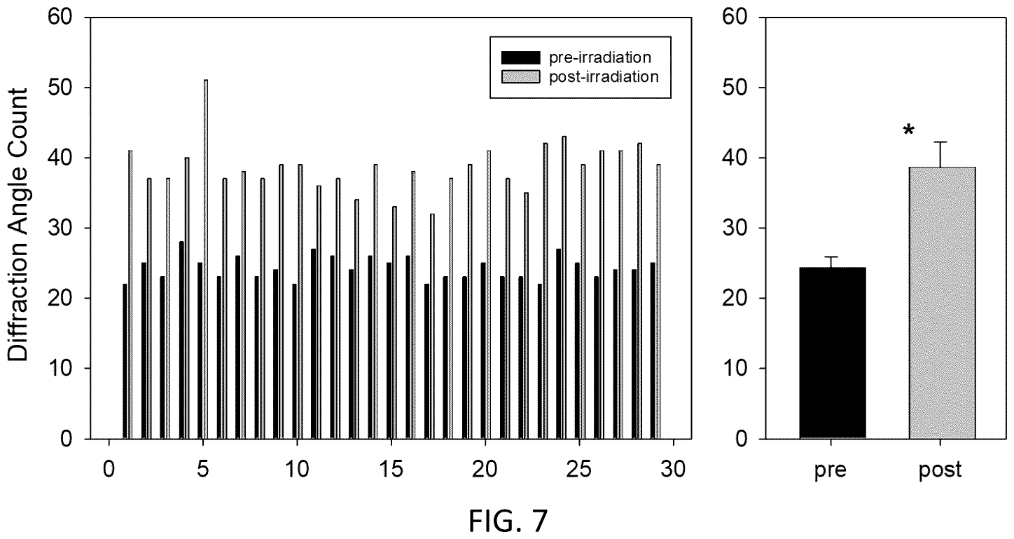

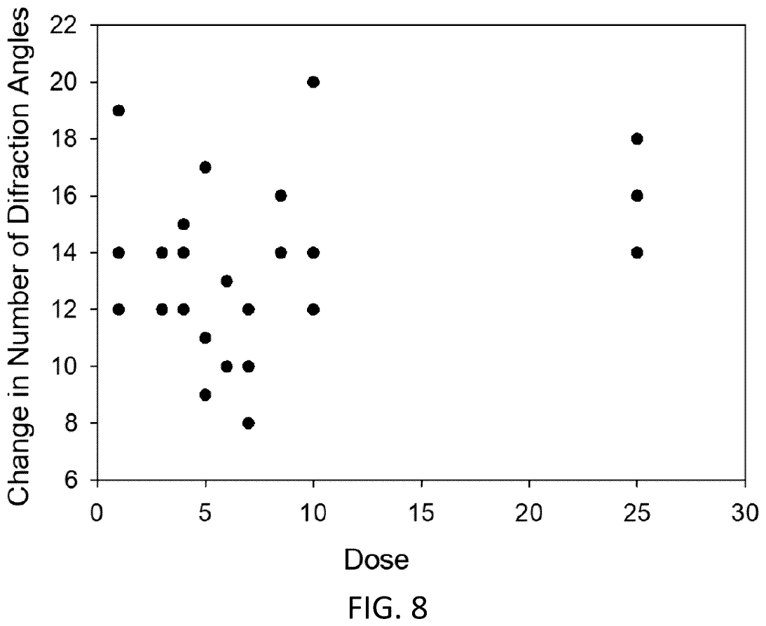

Alanine samples were exposed to a range of mixed field doses to investigate the dependence of crystal changes on dose. However, a regression analysis to determine if there was a correlation between the change in diffraction angles and mixed field dose that is associated with the change did not show a correlation as seen in FIG. 8. While the change in 2θ angles in alanine presumably results from the presence of neutrons in the exposure field (FIG. 7), a strong relationship between the mixed field dose and the increased number of diffraction angles cannot yet be observed. Since the dose rate was kept constant for all mixed field samples, the other component of the field that could influence the results would be the energy of the neutrons in the field, which was not explored here.

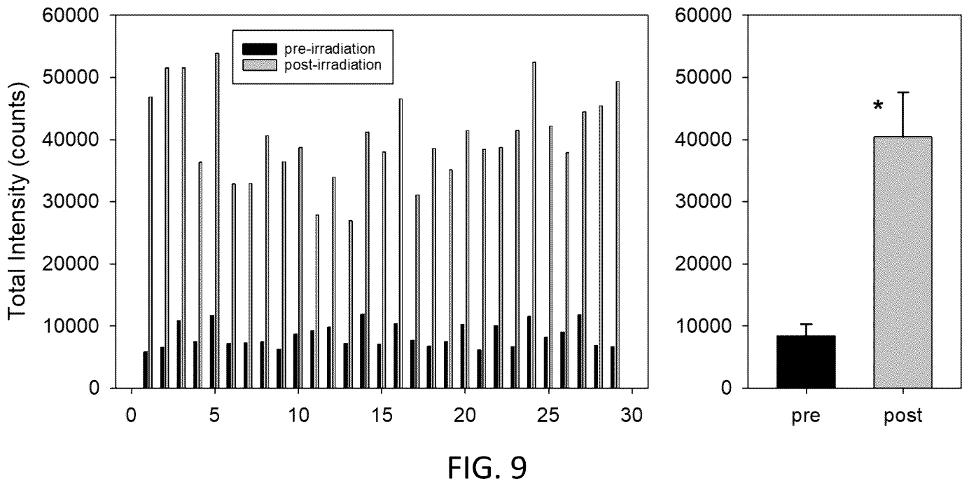

The maximum number of diffraction angles and counts seen prior to mixed field irradiation across all measured samples were 28 and 11748 respectively, versus 51 and 52441 seen post irradiations. These results show evidence that there is meaningful change in the characteristics of the crystal lattice post-irradiation in the mixed field that is not seen when samples are irradiated in only a gamma field. Current work is not able to quantify the cause and effects of the difference in field spectra; however, future data collections will focus on the development of a response function for the dosimeter in the field which may relate the neutron dose to the addition of lattice diffraction angles or the higher rate of X-ray interactions with electrons in the sample or some other metric quantifying the crystal damage. FIG. 9 is analogous to FIG. 7, in that it shows a strong effect of mixed field radiation on the count of X-rays diffracted from crystal planes in the XRD post-irradiation. To correlate the change to the amount of energy deposited or dose measurement, a detailed knowledge of the neutron spectrum in the field at the exact location the irradiation occurred would need to be measured. The nonlinear relationship between the diffractometer scanned response and the dose could be inferred by considering the energy dependent neutron fluence causing damage to the samples. This relationship is most likely based on the interaction cross section of the incident neutrons, the alanine sample, and the distribution of neutron fluence during irradiation.

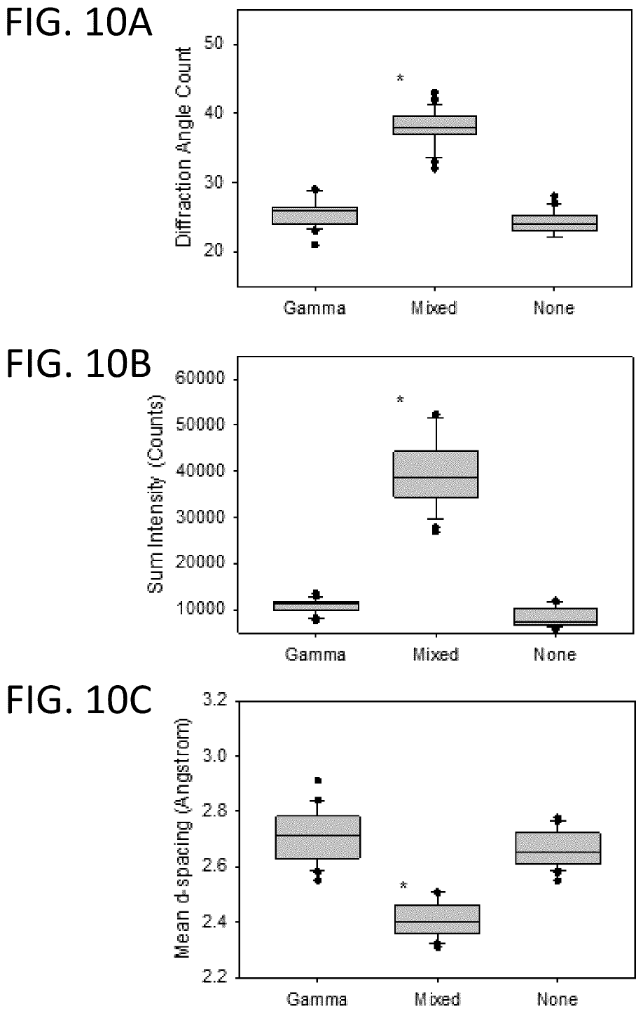

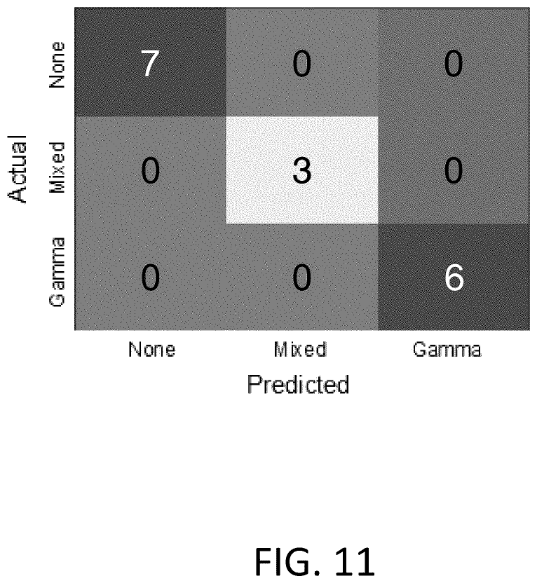

FIG. 10 illustrates comparative box plot analyses of X-ray diffraction (XRD) parameters across three radiation conditions: gamma-only exposure, mixed-field exposure, and no radiation (unirradiated controls). As shown in FIG. 10A, the number of distinct diffraction angles detected in each sample group varies significantly, with mixed-field samples exhibiting a broader distribution relative to gamma-only and control groups. FIG. 10B presents total intensity values, where mixed-field exposure results in elevated cumulative counts. FIG. 10C depicts mean d-spacing values, which reflect average interplanar atomic spacing. Statistical analysis using one-way ANOVA reveals a significant difference among groups (p<0.001), and data points marked with an asterisk (*) denote statistically significant deviations compared to either gamma-only or unirradiated controls (p<0.001). These results support the hypothesis that mixed-field radiation induces distinct and quantifiable changes in crystalline structure, which may be leveraged for dosimetric classification or predictive modeling.

In some embodiments, the system may be configured to analyze XRD data by extracting key spectral features beyond the number of lattice diffraction angles, including the sum of peak intensities, average peak tip width, average full width at half maximum (FWHM), average d-spacing, and average relative intensity. Each sample in the dataset contains six spectra, each defined as a function of diffraction angle, with a maximum of 53 points per spectrum. From these spectra, six attributes are extracted: (1) Pos. [° 2θ], the angle between incident and diffracted beams; (2) Height [cts], the total number of diffracted rays, proportional to electron interactions; (3) FWHM Left [° 2θ], the resolution of each peak; (4) d-spacing [A], the atomic spacing between lattice planes; (5) Rel. Int. [%], the ratio of peak intensity to the maximum; and (6) Tip Width, a measure of peak sharpness. These features are used to characterize material changes resulting from radiation exposure.

To study the ability for models to identify gamma exposure in mixed radiation fields using XRD, the assembled a dataset comprising 77 samples, which included 26 samples subjected to mixed-field exposure, 21 samples exposed to gamma-only radiation, and 30 non-irradiated controls. The study employed rule-based and tree-based classification algorithms. Categorical variables were converted to numeric dummy variables, and the dataset was divided into training and testing subsets, with 80% (60 samples) allocated for training and 20% (16 samples) for testing. The target variable was extracted as a Y matrix, while the remaining features comprised the X matrix. Both logistic regression and K-nearest neighbors (KNN) classifier algorithms were trained on the data, each achieving 100% classification accuracy. The performance of these models is demonstrated using a confusion matrix (see FIG. 10), which displayed true positives, true negatives, false positives, and false negatives for each class. These results confirmed that machine learning classification algorithms applied to XRD data could accurately predict the type of radiation field.

As used herein, the terms “approximately,” “about,” and similar expressions are intended to convey a degree of flexibility in the stated values and should be interpreted in accordance with standard usage in the relevant technical field. Where no established standard exists, such terms shall be understood to mean within ±10% of the associated stated value. This interpretation is intended to account for variations that may arise due to manufacturing tolerances, measurement limitations, or other practical considerations.

Any discussion of theories of operation or underlying principles herein is provided solely for explanatory purposes. Such descriptions are not intended to limit the scope of the claimed subject matter in any way. The technology disclosed may function in accordance with these theories or in other ways without departing from the scope of the claims.

Terms such as “over,” “under,” “above,” “below,” and similar expressions are used herein to describe relative positions of elements and are not intended to require any particular absolute orientation. For example, a layer described as being “on top of” or “over” another layer may, in an assembled device, be positioned beneath that other layer. Such terminology is used for convenience of description and does not limit the scope of the claimed subject matter.

The specific examples, embodiments, and experimental results described herein are provided solely for purposes of illustration. They are not intended to represent the only forms in which the disclosed technology may be practiced. Variations, modifications, and alternative implementations will be apparent to those skilled in the art in view of this disclosure. The scope of the claimed subject matter encompasses such alternatives and is not limited to the particular examples presented. Accordingly, the examples and experiments should not be construed as limiting the invention in any way.

1. A method, comprising:
obtaining an X-ray diffraction (XRD) spectrum of a sample of a crystalline material;
comparing the obtained XRD spectrum to a reference XRD spectrum associated with the crystalline material;
determining neutron radiation exposure based on the comparison; and
outputting the neutron radiation exposure.

2. The method of claim 1, wherein outputting the neutron radiation exposure comprises outputting a positive indication of neutron radiation exposure.

3. The method of claim 1, wherein outputting the neutron radiation exposure comprises outputting a measure of neutron radiation exposure dose.

4. The method of claim 1, wherein the crystalline material comprises an organic crystalline material.

5. The method of claim 4, wherein the organic crystalline material comprises an amino-acid based crystalline material.

6. The method of claim 5, wherein the amino-acid based crystalline material comprises alanine.

7. The method of claim 1, further comprising:
determining a set of X-ray diffraction (XRD) feature measurements from the obtained XRD spectrum;
inputting the set of XRD feature measurements into a computational model trained to correlate XRD features with neutron radiation dosage; and
outputting a dosage value from the model indicative of the neutron radiation exposure received by the sample.

8. A device, comprising:
a receptacle configured to receive a sample of the crystalline material;
an X-ray spectrometer configured to obtain an X-ray diffraction (XRD) spectrum of the sample;
circuitry configured to compare the obtained XRD spectrum to a reference XRD spectrum associated with the crystalline material and determine neutron radiation exposure based on the comparison; and
an output interface configured to output the neutron radiation exposure.

9. The device of claim 8, wherein the output interface is configured to output a positive indication of neutron radiation exposure or a measure of neutron radiation exposure dose.

10. The device of claim 8, wherein the crystalline material comprises an organic crystalline material.

11. The device of claim 10, wherein the organic crystalline material comprises alanine.

12. The device of claim 8, wherein the circuitry is further configured to:
determine a set of X-ray diffraction (XRD) feature measurements from the obtained XRD spectrum;
input the set of XRD feature measurements into a computational model trained to correlate XRD features with neutron radiation dosage; and
output a dosage value from the model indicative of the neutron radiation exposure received by the sample.

13. The device of claim 12, wherein the circuitry comprises a processor and a non-transitory computer-readable medium storing instructions, or an application-specific integrated circuit (ASIC).

14. A non-transitory computer-readable medium storing instructions that, when executed by one or more processors, cause the one or more processors to:
obtain an X-ray diffraction (XRD) spectrum of a sample of a crystalline material;
compare the obtained XRD spectrum to a reference XRD spectrum associated with the crystalline material;
determine neutron radiation exposure based on the comparison; and
output the neutron radiation exposure.

15. The computer-readable medium of claim 14, wherein outputting the neutron radiation exposure comprises outputting a positive indication of neutron radiation exposure.

16. The computer-readable medium of claim 14, wherein outputting the neutron radiation exposure comprises outputting a measure of neutron radiation exposure dose.

17. The computer-readable medium of claim 14, wherein the crystalline material comprises an organic crystalline material.

18. The computer-readable medium of claim 17, wherein the amino-acid based crystalline material comprises alanine.

19. The computer-readable medium of claim 18, wherein the alanine comprises alpha-alanine.

20. The computer-readable medium of claim 14, wherein the instructions further cause the one or more processors to:
determine a set of X-ray diffraction (XRD) feature measurements from the obtained XRD spectrum;
input the set of XRD feature measurements into a computational model trained to correlate XRD features with neutron radiation dosage; and
output a dosage value from the model indicative of the neutron radiation exposure received by the sample.
